(19) United States
(12) Patent Application Publication
(10) Pub. No.: US 2021/0090106 A1
(43) Pub. Date: Mar. 25, 2021

(54) SYSTEMS AND METHODS FOR OUTBOUND FORECASTING

(71) Applicant: Coupang, Corp., Seoul (KR)

(72) Inventors: Bin Gu, Shanghai (CN); Christopher Carlson, Seoul (KR); Li Huang, Shanghai (CN); Ke Ma, Shanghai (CN); Xiang Li, Shanghai (CN)

(73) Assignee: Coupang, Corp., Seoul (KR)

(21) Appl. No.: 16/578,901

(22) Filed: Sep. 23, 2019

(51) Int. Cl. G06Q 30/02; G06Q 10/08; G06Q 10/04; G06Q 50/28; G06Q 10/06

(52) U.S. Cl. CPC G06Q 30/0205; G06Q 10/087; G06Q 10/067; G06Q 50/28; G06Q 10/06315; G06Q 10/04

(57) ABSTRACT

The embodiments of the present disclosure provide systems and methods for outbound forecasting, comprising receiving an initial set of solutions comprising receiving a prediction of a regional sales forecast indicative of a customer demand for each stock keeping unit (SKU) in a plurality of regions, receiving a prediction of a correlation of one or more SKUs that will be combined in customer orders in the plurality of regions, receiving a prediction of a size of customer orders in the plurality of regions, wherein a customer order profile is simulated based on the predicted correlation and the predicted size, applying a fulfillment center (FC) priority filter to the simulated customer order profile, predicting a FC for managing outbound of each SKU based on the predicted regional sales forecast and the simulated customer order profile, and modifying a database to assign the predicted FC to each corresponding SKU.

### TECHNICAL FIELD

The present disclosure generally relates to computerized systems and methods for outbound forecasting. In particular, embodiments of the present disclosure relate to inventive and unconventional systems related to outbound forecasting by simulating a customer order profile and applying a fulfillment center (FC) priority filter to the simulated customer order profile.

### BACKGROUND

Typically, when customer orders are made, the orders must be transferred to one or more fulfillment centers. However, customer orders, especially online customer orders, are made by many different customers located at many different regions, and as such, the orders are bound for many different destinations. Therefore, the orders must be properly sorted such that they are routed to an appropriate fulfillment center and, ultimately, correctly routed to their destination.

Systems and methods for optimizing shipping practices and identifying shipping routes for outbound products already exist. For example, conventional methods simulate shipments according to shipping routes. In order to determine the optimal routing plan, an alternative routing module can modify package routing data according to a user input. That is, the user may manually change data associated with the original package routing data and view the effects of each routing change. This process is repeated until the optimal routing plan is determined.

However, these conventional systems and methods for outbound forecasting of products is difficult, time-consuming, and inaccurate mainly because they require manual modification and repeated testing of individual combinations of parameters. Especially for entities with multiple fulfillment centers throughout the region, it is significantly challenging and time-consuming to replicate outbound flow of products at all levels of processes, including the level at which customer orders are initially received, the level at which inbound/stowing/inventory estimates are determined, and the level at which logic to assign orders to various fulfillment centers is determined. In addition, because conventional systems and methods require manual modification and repeated testing after each modification, simulation can only be done on a larger scale, rather than on a granular scale. For example, simulation can only be done on a product type by product type basis, rather than on a stocking keeping unit (SKU) by SKU basis.

In addition, conventional systems and methods for forecasting outbound flow of products do not allow for a “what if” analysis. That is, conventional systems and methods do not take into consideration certain events, such as an unexpected increase in customer demand for a particular product, that could arise and significantly affect future outbound flow of products.

Therefore, there is a need for improved systems and methods for outbound forecasting of products. In particular, there is a need for improved systems and methods for outbound forecasting based on customer order profiles that have been simulated based on one or more parameters associated with past customer orders. In addition, there is a need for improved systems and methods for outbound forecasting based on simulations generated by simulation algorithm that analyzes one or more parameters associated with past customer orders and currently pending customer orders.

### SUMMARY

One aspect of the present disclosure is directed to a computer-implemented system for outbound forecasting. The system may comprise a memory storing instructions and at least one processor configured to execute the instructions. The at least one processor may be configured to execute the instructions to receive, from a sales forecast system, a prediction of a regional sales forecast indicative of a customer demand for each stock keeping unit (SKU) in each region, receive, from a SKU correlation system, a prediction of a correlation of one or more SKUs that will be combined in customer orders in each region, and receive, from an order size calculation system, a prediction of a size of customer orders in each region. A customer order profile may be simulated based on the predicted correlation and the predicted size. The at least one processor may also be configured to execute the instructions to apply a fulfillment center (FC) priority filter to the simulated customer order profile, predict a FC, among a plurality of FCs, for managing outbound of each SKU based on the predicted regional sales forecast and the simulated customer order profile, and modify a database to assign the predicted FC to each corresponding SKU.

In some embodiments, the at least one processor may be further configured to execute the instructions to simulate inventory using at least one of open purchase orders or past customer orders. Open purchase orders may comprise unfulfilled customer orders. In some embodiments, the at least one processor may be further configured to execute the instructions to predict the FC for managing outbound of each SKU based on the simulated inventory.

In some embodiments, predicting the FC may further comprise selecting a FC, among the plurality of FCs, with a highest priority level. In other embodiments, predicting the FC may further comprise selecting a FC, among the plurality of FCs, capable of delivering a maximum number of the one or more SKUs that will be combined in customer orders. In some embodiments, the FC priority filter may vary based on each customer order. In some embodiments, receiving the prediction of the regional sales forecast may further comprise separating national sales forecast into each region. In some embodiments, the at least one processor may be further configured to execute the instructions to predict inventory at the predicted FC on a particular future date. In yet another embodiment, the steps of receiving the prediction of the regional sales forecast, receiving the prediction of the correlation of one or more SKUs, receiving the prediction of the size of customer orders in each region, applying the FC priority filter to the simulated customer order profile, and predicting the FC for managing outbound of each SKU may be repeated based on a number of days of outbound forecasting.

Another aspect of the present disclosure is directed to a computer- implemented method for outbound forecasting. The method may comprise receiving, from a sales forecast system, a prediction of a regional sales forecast indicative of a customer demand for each stock keeping unit (SKU) in each region, receiving, from a SKU correlation system, a prediction of a correlation of one or more SKUs that will be combined in customer orders in each region, and receiving, from an order size calculation system, a prediction of a size of customer orders in each region. A customer order profile may be simulated based on the predicted correlation and the predicted size. The method may also comprise applying a fulfillment center (FC) priority filter to the simulated customer order profile, predicting a FC, among a plurality of FCs, for managing outbound of each SKU based on the predicted regional sales forecast and the simulated customer order profile, and modifying a database to assign the predicted FC to each corresponding SKU.

In some embodiments, the method may further comprise simulating inventory using at least one of open purchase orders or past customer orders. Open purchase orders may comprise unfulfilled customer orders. In some embodiments, the method may further comprise predicting the FC for managing outbound of each SKU based on the simulated inventory.

In some embodiments, predicting the FC may further comprise selecting a FC, among the plurality of FCs, with a highest priority level. In other embodiments, predicting the FC may further comprise selecting a FC, among the plurality of FCs, capable of delivering a maximum number of the one or more SKUs that will be combined in customer orders. In some embodiments, the FC priority filter may vary based on each customer order. In some embodiments, receiving the prediction of the regional sales forecast may further comprise separating national sales forecast into each region. In some embodiments, the method may further comprise predicting inventory at the predicted FC on a particular future date.

Yet another aspect of the present disclosure is directed to a computer-implemented system for outbound forecasting. The system may comprise a memory storing instructions and at least one processor configured to execute the instructions. The at least one processor may be configured to execute the instructions to receive, from a sales forecast system, a prediction of a regional sales forecast indicative of a customer demand for each stock keeping unit (SKU) in each region, receive, from a SKU correlation system, a prediction of a correlation of one or more SKUs that will be combined in customer orders in each region, and receive, from an order size calculation system, a prediction of a size of customer orders in each region. A customer order profile may be simulated based on the predicted correlation and the predicted size. The at least one processor may also be configured to execute the instructions to apply a fulfillment center (FC) priority filter to the simulated customer order profile, simulate inventory using open purchase orders and past customer orders, predict a FC, among a plurality of FCs, for managing outbound of each SKU based on the predicted regional sales forecast, the simulated customer order profile, and the simulated inventory, and modify a database to assign the predicted FC to each corresponding SKU. Open purchase orders may comprise unfulfilled customer orders.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a schematic block diagram illustrating an exemplary embodiment of a system comprising an outbound forecasting system, consistent with the disclosed embodiments.

FIG. 4 is a schematic block diagram illustrating an exemplary embodiment of a system for outbound forecasting, consistent with the disclosed embodiments.

FIG. 5 is a diagram illustrating an exemplary embodiment of a method for predicting regional sales forecast, consistent with the disclosed embodiments.

FIG. 6 is a flowchart illustrating an exemplary embodiment of a method for outbound forecasting, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for outbound forecasting of products.

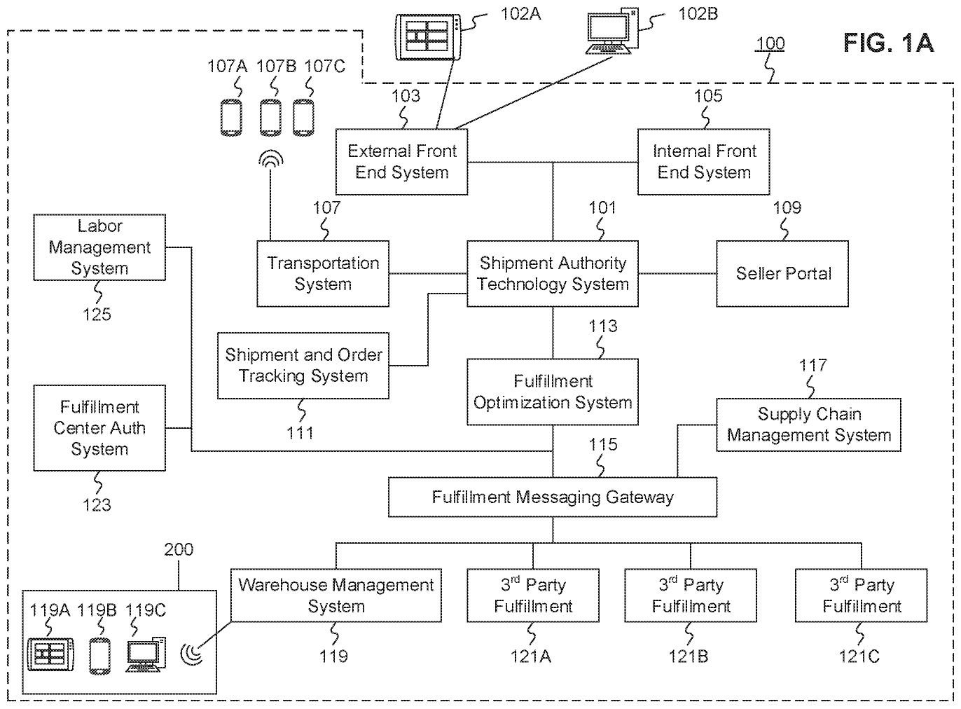

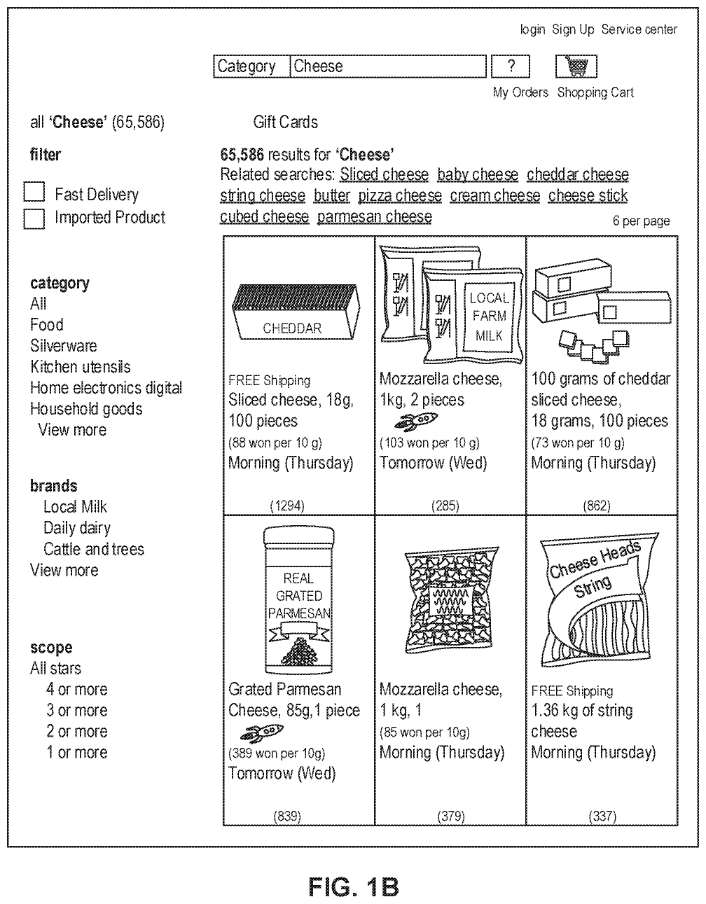

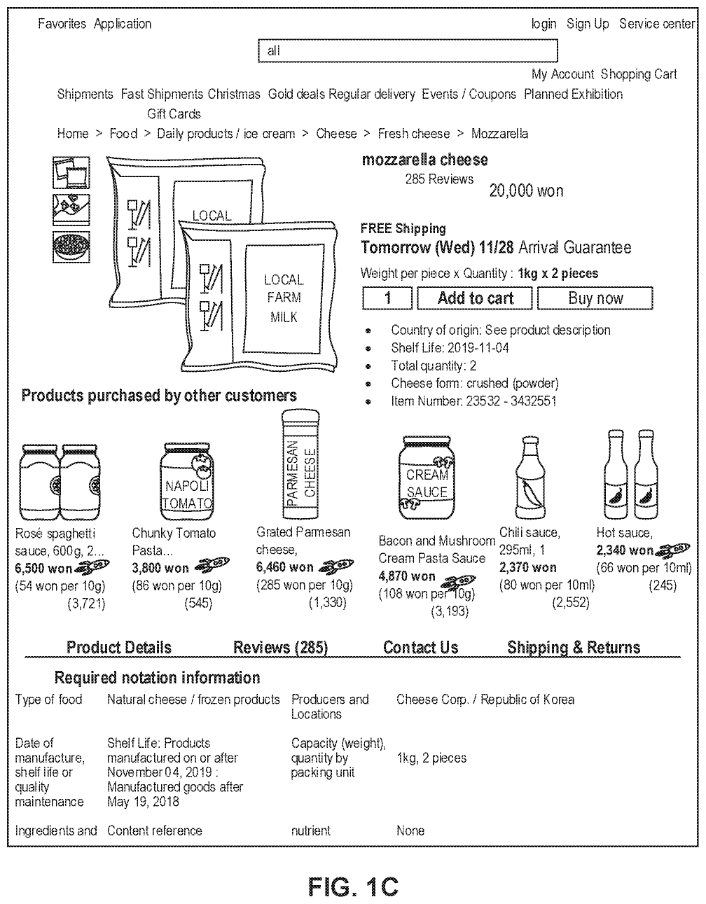

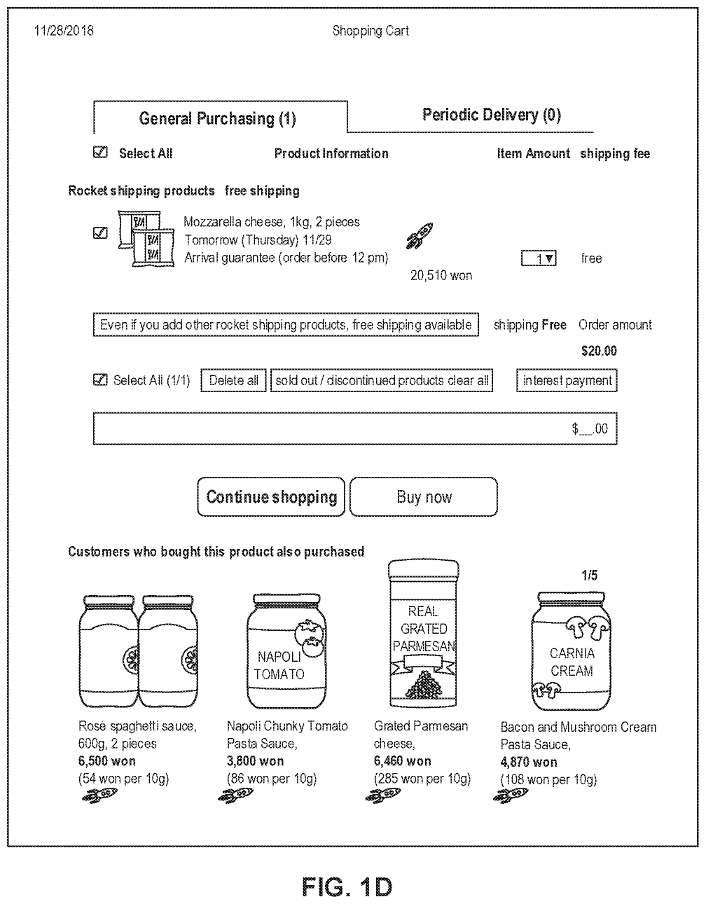

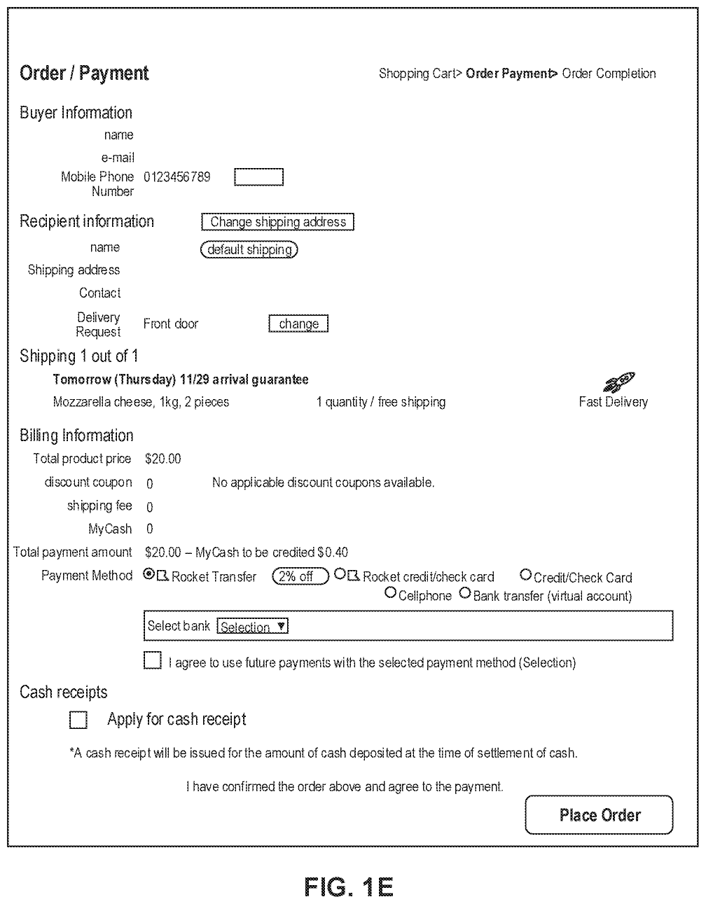

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 1078, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 1028) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

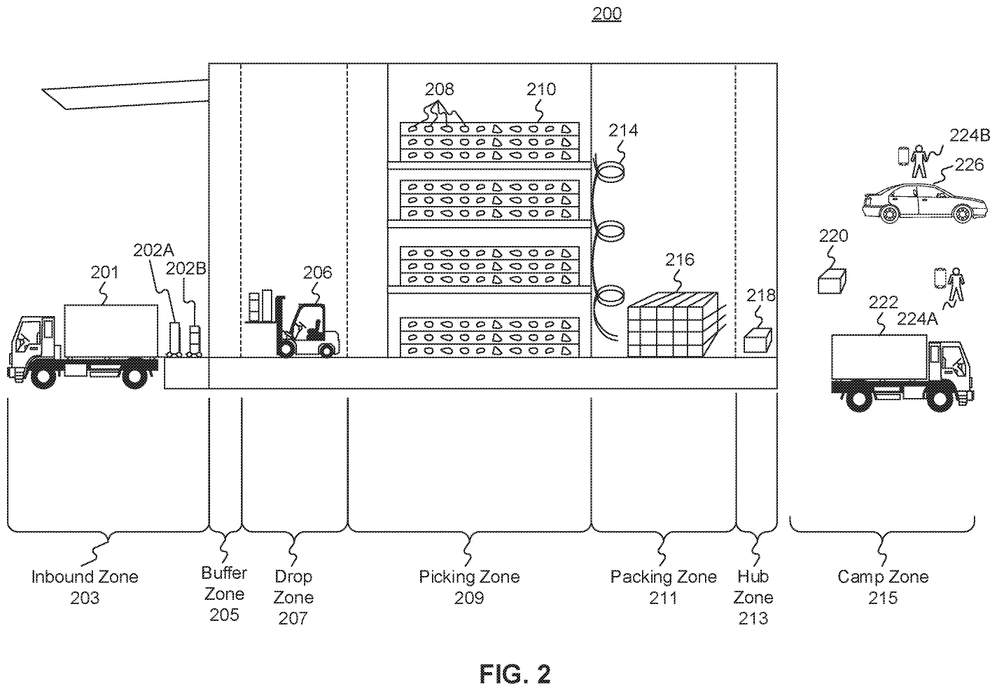

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3 PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3 PL systems 121A-121C may be configured to receive orders from FO system 113 (e.g., through FMG 115) and may provide products and/or services (e.g., delivery or installation) to customers directly. In some embodiments, one or more of 3 PL systems 121A-121C may be part of system 100, while in other embodiments, one or more of 3 PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1198.

Once a user places an order, a picker may receive an instruction on device 1198 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

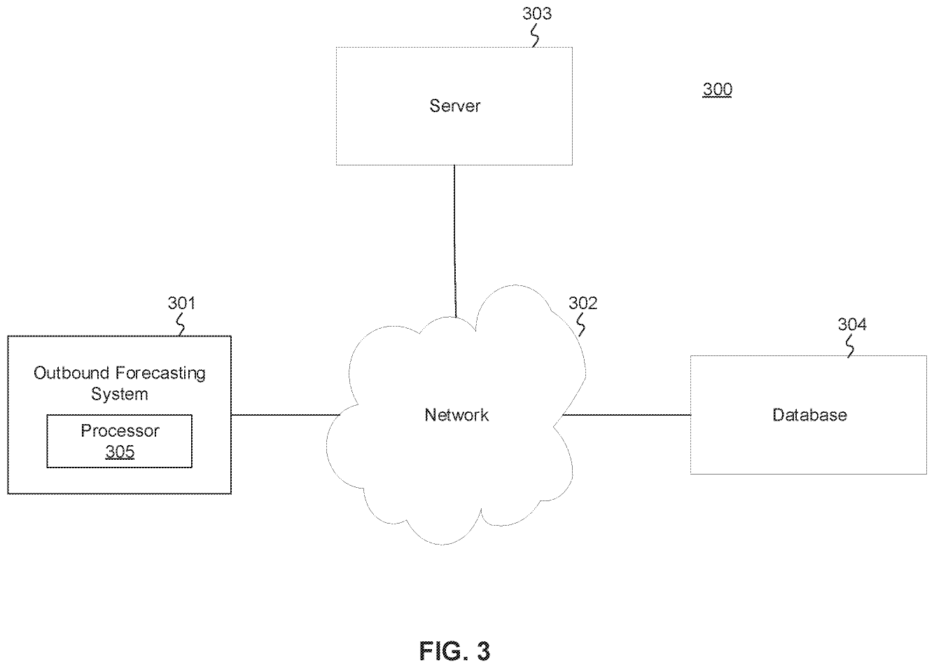

Referring to FIG. 3, a schematic block diagram 300 illustrating an exemplary embodiment of a system comprising an outbound forecasting system 301. Outbound forecasting system 301 may be associated with one or more systems in system 100 of FIG. 1A. For example, outbound forecasting system 301 may be implemented as part of SCM system 117. Outbound forecasting system 301, in some embodiments, may be implemented as a computer system that processes information for each FC 200 as well as information for customer orders from other systems (e.g., external front end system 103, shipment and order tracking system 111, and/or FO system 113). For example, outbound forecasting system 301 may include one or more processors 305, which may process information describing a distribution of SKUs among FCs and store the information in a database, such as database 304. One or more processors 305 of outbound forecasting system 301, thus, may process a list of SKUs that are stored in each FC and store the list in database 304. One or more processors 305 may also process information describing constraints associated with each of the FCs and store the information in database 304. For example, certain FCs may have constraints, including maximum capacity, compatibility with certain items due to size, refrigeration needs, weight, or other item requirements, costs of transfer, building restrictions, and/or any combination thereof. By way of example, certain items may be stored only in one fulfillment center, while certain other items may be stored in multiple fulfillment centers. In still other embodiments, certain fulfilment centers may be designed to store only a particular set of items (e.g., fresh produce or frozen products). One or more processors 305 may process or retrieve this information as well as associated information (e.g., quantity, size, date of receipt, expiration date, etc.) for each FC and store this information in database 304.

In some embodiments, one or more processors 305 of the outbound forecasting system 301 may also be configured to receive information from one or more systems in the SCM system 117. For example, one or more processors 305 may receive a prediction of a regional sales forecast indicative of a customer demand for each stock keeping unit (SKU) in each region from a sales forecast system. Additionally or alternatively, one or more processors 305 may receive a prediction of a correlation of one or more SKUs that will be combined in customer orders in each region from a SKU correlation system. Additionally or alternatively, one or more processors 305 may receive a prediction of a size of customer orders in each region from an order size calculation system. In some embodiments, one or more processors 305 may receive a simulated customer order profile that may be generated based on the predicted correlation and the predicted size. One or more processors 305 may forecast outbound of SKUs to FCs 200 based on the predicted regional sales forecast and/or the simulated customer order profile.

In other embodiments, one or more processors 305 may store forecasted outbound of SKUs to FCs 200 in a database 304. In some embodiments, outbound forecasting system 301 may retrieve information from the database 304 over network 302. Database 304 may include one or more memory devices that store information and are accessed through network 302. By way of example, database 304 may include Oracle™ databases, Sybase™ databases, or other relational databases or non-relational databases, such as Hadoop sequence files, HBase, or Cassandra. While database 304 is illustrated as being included in the system 300, it may alternatively be located remotely from system 300. In other embodiments, database 304 may be incorporated into optimization system 301. Database 304 may include computing components (e.g., database management system, database server, etc.) configured to receive and process requests for data stored in memory devices of database 304 and to provide data from database 304.

System 300 may also comprise a network 302 and a server 303. Outbound forecasting system 301, server 303, and database 304 may be connected and be able to communicate with each other via network 302. Network 302 may be one or more of a wireless network, a wired network or any combination of wireless network and wired network. For example, network 302 may include one or more of a fiber optic network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving data.

In addition, network 302 may include, but not be limited to, telephone lines, fiber optics, IEEE Ethernet 902.3, a wide area network (“WAN”), a local area network (“LAN”), or a global network such as the Internet. Also network 302 may support an Internet network, a wireless communication network, a cellular network, or the like, or any combination thereof. Network 302 may further include one network, or any number of the exemplary types of networks mentioned above, operating as a stand-alone network or in cooperation with each other. Network 302 may utilize one or more protocols of one or more network elements to which they are communicatively coupled. Network 302 may translate to or from other protocols to one or more protocols of network devices. Although network 302 is depicted as a single network, it should be appreciated that according to one or more embodiments, network 302 may comprise a plurality of interconnected networks, such as, for example, the Internet, a service provider's network, a cable television network, corporate networks, and home networks.

Server 303 may be a web server. Server 303, for example, may include hardware (e.g., one or more computers) and/or software (e.g., one or more applications) that deliver web content that can be accessed by, for example a user through a network (e.g., network 302), such as the Internet. Server 303 may use, for example, a hypertext transfer protocol (HTTP or sHTTP) to communicate with a user. The web pages delivered to the user may include, for example, HTML documents, which may include images, style sheets, and scripts in addition to text content.

A user program such as, for example, a web browser, web crawler, or native mobile application, may initiate communication by making a request for a specific resource using HTTP and server 303 may respond with the content of that resource or an error message if unable to do so. Server 303 also may enable or facilitate receiving content from the user so the user may be able to, for example, submit web forms, including uploading of files. Server 303 may also support server-side scripting using, for example, Active Server Pages (ASP), PHP, or other scripting languages. Accordingly, the behavior of server 303 can be scripted in separate files, while the actual server software remains unchanged.

In other embodiments, server 303 may be an application server, which may include hardware and/or software that is dedicated to the efficient execution of procedures (e.g., programs, routines, scripts) for supporting its applied applications. Server 303 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Server 303 may act as a set of components accessible to, for example, an entity implementing system 100, through an API defined by the platform itself.

In some embodiments, one or more processors 305 of outbound forecasting system 301 may implement simulation algorithms, such as genetic algorithms, to generate one or more simulations of outbound flow of products to one or more FCs. For example, based on information associated with each FC stored in database 304, one or more processors 305 may optimize outbound flow of products, e.g., SKUs, among one or more FCs. In some embodiments, one or more processors 305 may use at least one of the predicted regional sales forecast, the predicted correlation of one or more SKUs that will be combined in customer orders, or the predicted size of customer orders to simulate outbound flow of products to one or more FCs. In some embodiments, one or more processors 305 may apply a FC priority filter to a simulated customer order profile to simulate outbound flow of products. In some embodiments, one or more processors 305 may optimize outbound flow through SKU mapping. SKU mapping is the allocation of SKUs to FCs, and outbound network optimization may be achieved through SKU mapping. One or more processors 305 may generate a simulation, via SKU mapping, and each simulation may comprise different distribution of SKUs among FCs. Each simulation may be randomly generated. Accordingly, one or more processors 305 may find an optimal simulation by generating one or more simulations and selecting the optimal simulation that improves most upon the output rate of one or more FCs across a statewide, regional, or nationwide network. Determining an optimal simulation that improves upon the output rate may be crucial in optimizing outbound flow of products. For example, while it may be easier to place one of each item in each FC, this may not be optimal because the FC will run out of items quickly if customer demand for a particular item increases rapidly. Likewise, if all of one item is placed in a single FC, this may not be optimal because customers from various locations may want the item. Then, because the item will only be available in a single FC, costs to transfer the item from one FC to another FC may increase, and thus, the system will lose efficiency. Accordingly, the computerized embodiments directed to optimizing outbound flow of products provide novel and crucial systems for determining an optimal distribution of SKUs among FCs.

In yet another embodiment, one or more processors 305 may be able to implement one or more constraints, such as business constraints, to genetic algorithms. Constraints may include, for example, maximum capacity of each FC, item compatibility associated with each FC, costs associated with FC, or any other characteristics associated with each FC. Maximum capacity of each FC may include information associated with how many SKUs can be held at each FC. Item compatibility associated with each FC may include information associated with certain items that cannot be held at certain FCs due to size of the items, weight of the items, need for refrigeration, or other requirements associated with the items/SKUs. There may also be building restrictions associated with each FC that allow certain items to be held and prevent certain items to be held at each FC. Costs associated with each FC may include FC-to-FC transfer costs, cross-cluster shipment costs (e.g., shipping costs incurred from shipping items from multiple FCs), shipping costs incurred from cross-stocking items between FCs, unit per parcel (UPP) costs associated with having all SKUs in one FC, or any combination thereof.

In other embodiments, one or more processors 305 may cache one or more portions of the genetic algorithm in order to increase efficiency. For example, one or more portions of the genetic algorithm may be cached to obviate the need to re-run all portions of the algorithm each time a simulation is generated. One or more processors 305 may determine which portion(s) of the genetic algorithm may be cached based on whether there will be significant changes in each iteration. For example, some parameters may remain consistent each time a simulation is generated, while other parameters may change. The parameters that remain consistent each time will not need to be re-run each time a simulation is generated. Therefore, one or more processors 305 may cache these consistent parameters. For example, maximum capacity at each FC may not change each time a simulation is generated, and thus, may be cached. On the other hand, parameters that may vary per simulation may include, for example, customer order profiles, customer interest in each SKU across regions, or stowing models. Customer order profiles may refer to behavior of customer orders across a statewide, regional, or nationwide network. For example, customer order profiles may refer to ordering patterns of customer orders across a statewide, regional, or nationwide network. Customer interest in each SKU may refer to the amount of customer demand for each item across a statewide, regional, or nationwide network. Stowing models may refer to models indicating where a particular item is placed, such as a particular spot in picking zone 209 or a particular space on a storage unit 210 in each FC. Stowing models may vary for each FC. By caching one or more portions of the genetic algorithm, one or more processors 305 may increase efficiency and reduce processing capacity.

In some embodiments, another constraint added to the simulation algorithm may comprise customer demand at each of the FCs. One or more processors 305 may be able to determine customer demand at each of the FCs by looking at order histories at each of the FCs. In other embodiments, one or more processors 305 may simulate customer demand at each of the FCs. For example, based on at least the order histories at each FC, one or more processors 305 may predict and/or simulate customer demand at each FC. Based on at least the simulated customer demand at each of the FCs, one or more processors 305 may allocate the SKUs among the FCs in order to optimize SKU allocation, SKU mapping, and outbound flow of products.

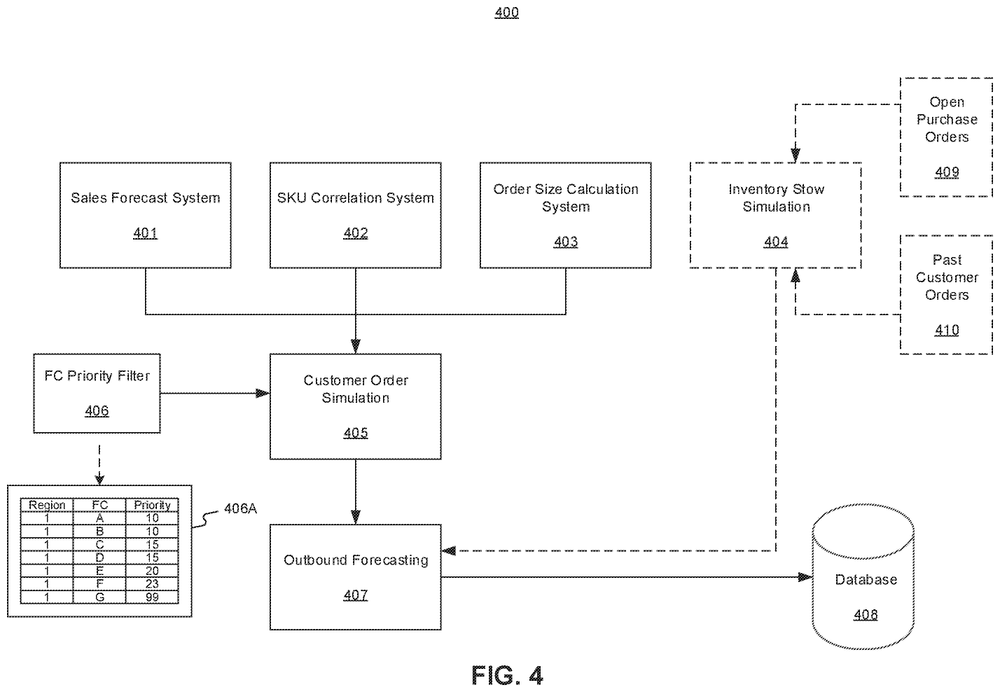

FIG. 4 is a schematic block diagram illustrating an exemplary embodiment of a system 400 for outbound forecasting. In some embodiments, system 400 may be implemented as part of SCM system 117. System 400 may comprise a sales forecast system 401, a SKU correlation system 402, an order size calculation system 403, and an outbound forecasting system 407. The outbound forecasting system 407 may be implemented as the outbound forecasting system 301 of FIG. 3. Additionally or alternatively, system 400 may also comprise an inventory stow simulation system 404.

The sales forecast system 401 may be an application running on a server, such as server 303. The sales forecast system 401 may be configured to predict a regional sales forecast. In some embodiments, the sales forecast system 401 may be configured to predict a regional sales forecast by calculating a sales forecast on a national level, e.g., national sales forecast, and calculating a regional ratio for each region. The regional ratio may be calculated based on data associated with past customer demand. Accordingly, the sales forecast system 401 may separate the national sales forecast into each region, thereby generating a prediction of a regional sales forecast for each region. The regional sales forecast, in some embodiments, may be indicative of a customer demand for each SKU in each region. For example, the regional sales forecast may be indicative of a quantity of each product sold in each region, based on past customer orders.

The SKU correlation system 402 may be configured to predict a correlation of one or more SKUs that will be combined in customer orders in each region. For example, the SKU correlation system 402 may retrieve past customer orders, such as past customer orders 410 and determine the likelihood of possible combinations of SKUs in a single customer order. Based on the determined likelihood of possible combinations of SKUs in past customer orders, the SKU correlation system 402 may be configured to calculate a possibility of one or more SKUs that may be consistently combined together in customer orders. As such, the SKU correlation system 402 may be configured to predict a correlation of one or more SKUs that are most likely to be combined together in customer orders in each region.

The order size calculation system 403 may be configured to predict a size of customer orders in each region. For example, the order size calculation system 403 may be configured to calculate how many different SKUs are likely to be in one customer order in each region. In some embodiments, the correlation predicted by the SKU correlation system 402 and the customer order size predicted by the order size calculation system 403 may be used to simulate a customer order 405.

The outbound forecasting system 407 may receive the regional sales forecast from the sales forecast system 401, the correlation predicted by the SKU correlation system 402, the customer order size predicted by the order size calculation system 403, and the customer order simulation 405. The outbound forecasting system 407 may predict a FC, among a plurality of FCs, for managing outbound of each SKU based on the predicted regional sales forecast and the simulated customer order profile. For example, the outbound forecasting system 407 may determine an allocation of SKUs among the plurality of FCs that may optimize outbound flow of the network of FCs. The outbound forecasting system 407 may modify a database 408 to assign the predicted FC to each corresponding SKU. That is, the outbound forecasting system 407 may store the allocation of SKUs among the FCs in database 408.

In some embodiments, the outbound forecasting system 407 may apply a FC priority filter 406 to the simulated customer order profile 405. The FC priority filter 406 may be generated, for example, by one or more processors of the outbound forecasting system 407. The FC priority filter 406 may be generated using a simulation algorithm, such as a genetic algorithm. For example, one or more processors of the outbound forecasting system 407 may randomly generate an initial distribution of priority values to each FC in each region. Then, one or more processors may run a simulation, using the simulation algorithm and/or the genetic algorithm, of the initial distribution of priority values. One or more processors may also calculate an outbound capacity utilization of each FC, based on the initial distribution of priority values. The outbound capacity utilization of each FC may comprise a ratio of an outbound of each FC to an outbound capacity of each FC. Then, one or more processors may determine a number of FCs comprising an outbound capacity utilization value that exceeds a minimum outbound value of each FC. One or more processors may feed the simulation algorithm with at least one of the determined number of FCs to generate one or more additional distributions of priority values in order to generate the FC priority filter 406. The FC priority filter 406 may comprise an optimal distribution of priority values to each FC that will maximize the number of FCs in the network having an outbound capacity utilization value that exceeds the minimum outbound value of each FC.

Using the FC priority filter 406, one or more processors of the outbound forecasting system 407 may perform a first-in-first-out (FIFO) setting, in which one or more processors assign an FC with the highest priority value first to a particular SKU and calculate an outbound capacity utilization value of each FC. Then, one or more processors may assign a next FC with the next highest priority value to the particular SKU and calculate an outbound capacity utilization value of each FC. One or more processors may repeat these steps until one or more processors determine an optimal allocation of SKUs among the FCs that will maximize the number of FCs in the network having an outbound capacity utilization value that exceeds the minimum outbound value of each FC. Based on the optimal allocation of SKUs among the FCs, one or more processors of the outbound forecasting system 407 may predict a FC for managing outbound of each SKU. In some embodiments, the predicted FC may be an FC, among the plurality of FCs that can be assigned to a particular SKU, with a highest priority value. In other embodiments, the predicted FC may be an FC, among a plurality of FCs that can be assigned to a particular SKU, that is capable of delivering a maximum number of the one or more SKUs combined in the simulated customer order profile. In some embodiments, the FC priority filter may vary based on each simulated customer order profile. For example, the FC priority filter may be adjusted based on the one or more SKUs in a simulated customer order profile.

In some embodiments, system 400 may comprise an inventory stow simulation system 404. The inventory stow simulation system 404 may be configured to simulate an inventory at each FC in each region based on at least one of open purchase orders 409 or past customer orders 410. Open purchase orders 409 may comprise unfulfilled customer orders, e.g., customer orders that have not been processed yet. In some embodiments, the outbound forecasting system 407 may also use the simulated inventory from the inventory stow simulation system 404 to predict the FC for managing outbound of each SKU.

In some embodiments, the one or more processors of the outbound forecasting system 407 may be configured to predict or simulate inventory at the predicted FC on a particular future date, e.g., x days from today. In order to predict or simulate inventory at the predicted FC on a particular future date, one or more processors may be configured to repeat the steps of receiving the prediction of the regional sales forecast, receiving the prediction of the correlation of one or more SKUs, receiving the prediction of the size of customer orders in each region, applying the FC priority filter to the simulated customer order profile, and predicting the FC for managing outbound of each SKU based on a number of days of outbound forecasting. For example, one or more processors may repeat the steps 3 times if predicting inventory at the predicted FC on a date 3 days from today. Similarly, one or more processors may repeat the steps 5 times if predicting inventory at the predicted FC on a date 5 days from today.

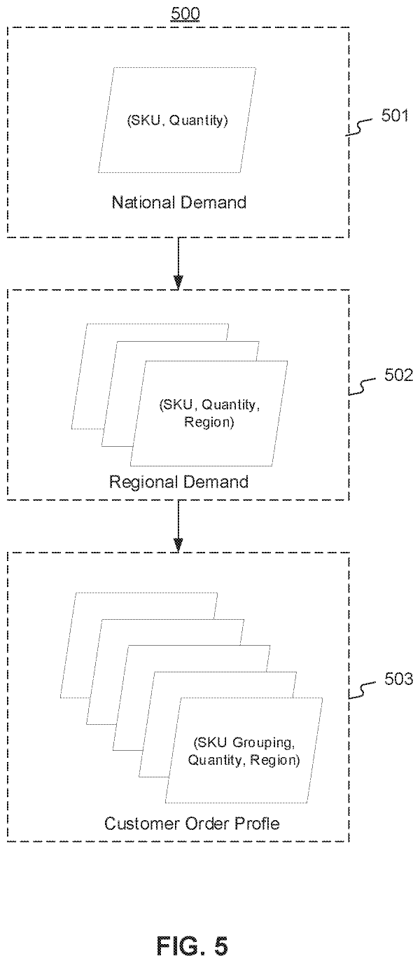

FIG. 5 illustrates a diagram illustrating an exemplary embodiment of a method 500 for predicting regional sales forecast, consistent with the disclosed embodiments. This exemplary method is provided by way of example. Method 500 shown in FIG. 5 can be executed or otherwise performed by one or more combinations of various systems. Method 500 as described below may be carried out by the system 400, as shown in FIG. 4. By way of example, method 500 may be carried out by the sales forecast system 401 of system 400, and the sales forecast system 401 is referenced in explaining the method of FIG. 5. Referring to FIG. 5, exemplary method 500 may begin at block 501.

At block 501, one or more processors of the sales forecast system 401 may calculate a sales forecast on a national level and acquire a national sales forecast. The national sales forecast may be indicative of a national customer demand for a particular SKU. For example, one or more processors of the sales forecast system 401 may determine a national customer demand for each SKU and calculate a quantity of each SKU that has been sold on a national level. One or more processors of the sales forecast system 401 may determine the national sales forecast based on data associated with past customer orders, such as past customer orders 410, saved in a database, such as database 304.

After receiving the national sales forecast at block 501, method 500 may proceed to block 502. At block 502, one or more processors of the sales forecast system 401 may separate the national sales forecast into a regional level. For example, one or more processors may predict a regional sales forecast by calculating a regional ratio and multiplying the regional ratio with the national sales forecast. The regional ratio may be calculated based on data associated with past customer orders. The regional ratio, for example, may be indicative of a ratio of customer orders for each SKU originating in each region to the total number of customer orders for the SKU on a national level. The regional sales forecast, in some embodiments, may be indicative of a customer demand for each SKU in each region. For example, the regional sales forecast may be indicative of a quantity of each product sold in each region, based on past customer orders. As such, after separating the national sales forecast to a regional level, one or more processors may obtain a regional sales forecast. Based on the regional sales forecast, the sales forecast system 401 may predict a customer demand, e.g., a quantity, for each SKU in each region at block 502.

After obtaining the regional sales forecast, method 500 may proceed to block 503. At block 503, the regional sales forecast from block 502 may be used to simulate a customer order profile 503. A simulation of a customer order profile may be generated based on data associated with past customer orders stored in the database. For example, as discussed above, a SKU correlation may be predicted based on past customer orders. As discussed above, the SKU correlation system 402 may predict a correlation of one or more SKUs, e.g., SKU grouping, that are likely to be combined in a customer order in each region. Based on the predicted correlation of SKUs as well as the regional demand for each SKU, a customer order profile may be simulated at block 503. The simulated customer order profile may be used by the outbound forecasting system 407 to predict an optimal allocation of SKUs among the plurality of FCs in a network.

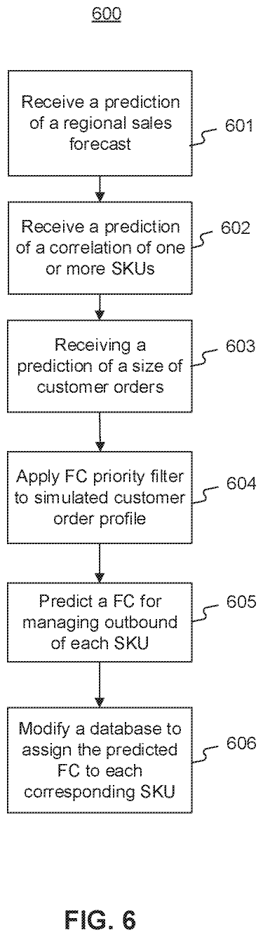

FIG. 6 is a flow chart illustrating an exemplary method 600 for outbound forecasting. This exemplary method is provided by way of example. Method 600 shown in FIG. 6 can be executed or otherwise performed by one or more combinations of various systems. Method 600 as described below may be carried out by the outbound forecasting system 301 or 407, as shown in FIGS. 3 and 4, respectively, by way of example, and various elements of the outbound forecasting system are referenced in explaining the method of FIG. 6. Each block shown in FIG. 6 represents one or more processes, methods, or subroutines in the exemplary method 600. Referring to FIG. 6, exemplary method 600 may begin at block 601.

At block 601, one or more processors 305 of the outbound forecasting system may receive a prediction of a regional sales forecast, for example from the sales forecast system 401 of FIG. 4. As discussed above, the sales forecast system 401 may be configured to predict a regional sales forecast by calculating a sales forecast on a national level, e.g., national sales forecast, and calculating a regional ratio for each region. The regional ratio may be calculated based on data associated with past customer demand. Accordingly, the sales forecast system 401 may separate the national sales forecast into each region, thereby generating a prediction of a regional sales forecast for each region. The regional sales forecast, in some embodiments, may be indicative of a customer demand for each SKU in each region. For example, the regional sales forecast may be indicative of a quantity of each product sold in each region, based on past customer orders. Accordingly, at block 601, one or more processors 305 of the outbound forecasting system may receive the prediction of a regional sales forecast from, for example, the sales forecast system 401.

Method 600 may proceed to block 602, at which one or more processors 305 may receive a prediction of a correlation of one or more SKUs. By way of example, one or more processors 305 may receive, from the SKU correlation system 402, a prediction of a correlation of one or more SKUs that will be combined in customer orders in each region. For example, the SKU correlation system 402 may be configured to calculate a possibility of one or more SKUs that may be consistently combined together in customer orders. As such, the SKU correlation system 402 may be configured to predict a correlation of one or more SKUs that are most likely to be combined together in customer orders in each region.

Method 600 may further proceed to block 603, at which one or more processors 305 may receive a prediction of a size of customer orders in each region. By way of example, one or more processors 305 may receive, from the order size calculation system 403, a prediction of a size of customer orders in each region. For example, the order size calculation system 403 may be configured to calculate how many different SKUs are likely to be in one customer order in each region. In some embodiments, the correlation predicted by the SKU correlation system 402 and the customer order size predicted by the order size calculation system 403 may be used to simulate a customer order, such as customer order profile 405.

After receiving the predictions and the simulated customer order profile at blocks 601-603, method 600 may proceed to block 604, at which one or more processors 305 may apply a FC priority filter, such as FC priority filter 406, to the simulated customer order profile. The FC priority filter may be generated, for example, by one or more processors 305 of the outbound forecasting system. The FC priority filter may be generated using a simulation algorithm, such as a genetic algorithm. For example, one or more processors 305 of the outbound forecasting system may randomly generate an initial distribution of priority values to each FC in each region. Then, one or more processors 305 may run a simulation, using the simulation algorithm and/or the genetic algorithm, of the initial distribution of priority values. One or more processors 305 may also calculate an outbound capacity utilization of each FC, based on the initial distribution of priority values. The outbound capacity utilization of each FC may comprise a ratio of an outbound of each FC to an outbound capacity of each FC. Then, one or more processors 305 may determine a number of FCs comprising an outbound capacity utilization value that exceeds a minimum outbound value of each FC. One or more processors 305 may feed the simulation algorithm with at least one of the determined number of FCs to generate one or more additional distributions of priority values in order to generate the FC priority filter. The FC priority filter may comprise an optimal distribution of priority values to each FC that will maximize the number of FCs in the network having an outbound capacity utilization value that exceeds the minimum outbound value of each FC.

After applying the FC priority filter to the simulated customer order profile, method 600 may proceed to block 605. At block 605, one or more processors 305 may predict a FC, among a plurality of FCs, for managing outbound of each SKU based on the predicted regional sales forecast and the simulated customer order profile. For example, one or more processors 305 may determine an allocation of SKUs among the plurality of FCs that may optimize outbound flow of the network of FCs. By way of example, one or more processors 305 may allocate the SKUs among the FCs using an FC priority filter that maximizes the number of FCs in the network having an outbound capacity utilization value that exceeds the minimum outbound value of each FC, in order to optimize outbound flow of the network of FCs.

After predicting the FC for managing outbound of each SKU, method 600 may proceed to block 606. At block 606, one or more processors 305 may modify a database, such as database 304 or 408, to assign the predicted FC to each corresponding SKU. That is, one or more processors 305 of the outbound forecasting system may store the allocation of SKUs among the FCs in the database.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for outbound forecasting, the system comprising:
a memory storing instructions; and
at least one processor configured to execute the instructions to:
receive, from a sales forecast system, a prediction of a regional sales forecast indicative of a customer demand for each stock keeping unit (SKU) in a plurality of regions;
receive, from a SKU correlation system, a prediction of a correlation of one or more SKUs that will be combined in customer orders in the plurality of regions;
receive, from an order size calculation system, a prediction of a size of customer orders in the plurality of regions, wherein a customer order profile is simulated based on the predicted correlation and the predicted size;
apply a fulfillment center (FC) priority filter to the simulated customer order profile;
predict a FC, among a plurality of FCs, for managing outbound of each SKU based on the predicted regional sales forecast and the simulated customer order profile;
modify a database to assign the predicted FC to each corresponding SKU;
generate one or more purchase orders to purchase a quantity of products associated with each SKU to satisfy the predicted regional sales forecast; and
send instructions to a plurality of mobile devices, each mobile device associated with a respective user physically in an FC, to stow the purchased quantity of products associated with each SKU in corresponding predicted FCs for shipping to customers,
wherein the FC priority filter is generated using a genetic algorithm and comprises an optimal distribution of priority values assigned to each FC that maximizes a number of FCs having an outbound capacity utilization value above a predetermined threshold.

2. The system of claim 1, wherein the at least one processor is further configured to execute the instructions to simulate inventory using at least one of open purchase orders or past customer orders.

3. The system of claim 2, wherein open purchase orders comprise unfulfilled customer orders.

4. The system of claim 2, wherein the at least one processor is further configured to execute the instructions to predict the FC for managing outbound of each SKU based on the simulated inventory.

5. The system of claim 1, wherein predicting the FC further comprises selecting a FC, among the plurality of FCs, with a highest priority level.

6. The system of claim 1, wherein predicting the FC further comprises selecting a FC, among the plurality of FCs, capable of delivering a maximum number of the one or more SKUs that will be combined in customer orders.

7. The system of claim 1, wherein the FC priority filter varies based on each customer order.

8. The system of claim 1, wherein receiving the prediction of the regional sales forecast further comprises separating national sales forecast into a plurality of regions.

9. The system of claim 1, wherein the at least one processor is further configured to execute the instructions to predict inventory at the predicted FC on a particular future date.

10. The system of claim 1, wherein the steps of receiving the prediction of the regional sales forecast, receiving the prediction of the correlation of one or more SKUs, receiving the prediction of the size of customer orders in the plurality of regions, applying the FC priority filter to the simulated customer order profile, and predicting the FC for managing outbound of each SKU are repeated based on a number of days of outbound forecasting.

11. A computer-implemented method for outbound forecasting, the method comprising:
receiving, from a sales forecast system, a prediction of a regional sales forecast indicative of a customer demand for each stock keeping unit (SKU) in a plurality of regions;
receiving, from a SKU correlation system, a prediction of a correlation of one or more SKUs that will be combined in customer orders in the plurality of regions;
receiving, from an order size calculation system, a prediction of a size of customer orders in the plurality of regions, wherein a customer order profile is simulated based on the predicted correlation and the predicted size;
applying a fulfillment center (FC) priority filter to the simulated customer order profile;
predicting a FC, among a plurality of FCs, for managing outbound of each SKU based on the predicted regional sales forecast and the simulated customer order profile;
modifying a database to assign the predicted FC to each corresponding SKU;
generating one or more purchase orders to purchase a quantity of products associated with each SKU to satisfy the predicted regional sales forecast; and
sending instructions to a plurality of mobile devices, each mobile device associated with a respective user physically in an FC, to stow the purchased quantity of products associated with each SKU in corresponding predicted FCs for shipping to customers,
wherein the FC priority filter is generated using a genetic algorithm and comprises an optimal distribution of priority values assigned to each FC that maximizes a number of FCs having an outbound capacity utilization value above a predetermined threshold.

12. The method of claim 11, further comprising simulating inventory using at least one of open purchase orders or past customer orders.

13. The method of claim 12, wherein open purchase orders comprise unfulfilled customer orders.

14. The method of claim 12, further comprising predicting the FC for managing outbound of each SKU based on the simulated inventory.

15. The method of claim 11, wherein predicting the FC further comprises selecting a FC, among the plurality of FCs, with a highest priority level.

16. The method of claim 11, wherein predicting the FC further comprises selecting a FC, among the plurality of FCs, capable of delivering a maximum number of the one or more SKUs that will be combined in customer orders.

17. The method of claim 11, wherein the FC priority filter varies based on each customer order.

18. The method of claim 11, wherein receiving the prediction of the regional sales forecast further comprises separating national sales forecast into the plurality of regions.

19. The method of claim 11, further comprising predicting inventory at the predicted FC on a particular future date.

20. A computer-implemented system for outbound forecasting, the system comprising:
a memory storing instructions; and
at least one processor configured to execute the instructions to:
receive, from a sales forecast system, a prediction of a regional sales forecast indicative of a customer demand for each stock keeping unit (SKU) in a plurality of regions;
receive, from a SKU correlation system, a prediction of a correlation of one or more SKUs that will be combined in customer orders in the plurality of regions;
receive, from an order size calculation system, a prediction of a size of customer orders in the plurality of regions, wherein a customer order profile is simulated based on the predicted correlation and the predicted size;
apply a fulfillment center (FC) priority filter to the simulated customer order profile;
simulate inventory using open purchase orders and past customer orders, wherein the open purchase orders comprise unfulfilled customer orders;
predict a FC, among a plurality of FCs, for managing outbound of each SKU based on the predicted regional sales forecast, the simulated customer order profile, and the simulated inventory;
modify a database to assign the predicted FC to each corresponding SKU;
generate one or more purchase orders to purchase a quantity of products associated with each SKU to satisfy the predicted regional sales forecast; and
send instructions to a plurality of mobile devices, each mobile device associated with a respective user physically in an FC, to stow the purchased quantity of products associated with each SKU in corresponding predicted FCs for shipping to customers,
wherein the FC priority filter is generated using a genetic algorithm and comprises an optimal distribution of priority values assigned to each FC that maximizes a number of FCs having an outbound capacity utilization value above a predetermined threshold.
